(19) United States
(12) Patent Application Publication
(10) Pub. No.: US 2005/0221927 A1
(43) Pub. Date: Oct. 6, 2005

(54) Power transmission system of engine

(75) Inventor: Mitsugi Chonan, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/094,197

(22) Filed: Mar. 31, 2005

(30) Foreign Application Priority Data
Apr. 5, 2004 (JP) 2004-111326

(51) Int. Cl. F16H 59/00; F16H 63/00; F16D 13/68

(52) U.S. Cl. 474/15; 474/17; 474/12

(57) ABSTRACT

A power transmission system has a crankshaft mounted rotatably on case and a primary shaft. A clutch drum of the centrifugal clutch is fixed to an inside end of the primary shaft. An inside end of the primary shaft is supported by a bearing for a first transmission, and an outside end of the primary shaft is supported by a bearing for a second transmission in case both of them. The primary shaft is rotatably supported by the outside end and the inside end fixing the clutch drum in the case. Thereby, assembling performance into which the primary shaft and the crankshaft of continuously variable transmission are coupled the crankshaft via the centrifugal clutch is enhanced.

### TECHNICAL FIELD OF THE INVENTION

The present invention relates to a continuously variable transmission in which a primary shaft is coaxially disposed at a crankshaft and a power transmission system which a power from an engine transmits to driving wheels.

### BACKGROUND OF THE INVENTION

A vehicle of running in unleveled land referred to as a buggy or ATV (All Terrain Vehicle) is off-road vehicle and is provided with four-wheels for one person, which is utilized for leisure such like hunting or trail-touring, and other than that, in part, practical vehicle for agriculture. The power transmission system for power generated from the engine for All Terrain Vehicle like this has a crankshaft activated by the engine, and a belt-type continuously variable transmission inputted via a centrifugal clutch from rotation of the crankshaft. The belt-type continuously variable transmission comprises a primary shaft at a side of an input shaft and a secondary shaft at a side of an output shaft which is parallel to the direction of the primary shaft. When the crankshaft is disposed coaxially to the primary shaft, the power transmission system is composed of two shafts.

Such as power transmission system of two axes configuration comprises, as described in Japanese Patent Application Laid-Open No. 11-123941, a centrifugal clutch being disposed between the crankshaft and the primary shaft coaxial therewith. When rotation of the crankshaft quickens up, the crankshaft is directly connected with the primary shaft by the centrifugal clutch, so that power from the engine is transmitted to the driving wheels via continuously variable transmission. Since the above-mentioned conventional power transmission system in which the output shaft of the centrifugal clutch engages with the primary shaft to couple on together, the conventional system requires mounting the following bearings: the system includes; two bearings for supporting both ends of the crankshaft at a crankcase; a bearing for supporting the clutch output shaft of the centrifugal clutch at the crankcase; a small bearing being positioned within the above bearing for clutch disposed between the crankshaft and the clutch output shaft; and a bearing for supporting the primary shaft at an outside end of the primary shaft. Therefore, the power transmission system is necessary to support two bearings for supporting both ends of the crankshaft, and the aforementioned three bearings are added, that is, five bearings support the crankshaft and the primary shaft in the case.

In the power transmission system, it is unavoidable to provide plural bearings in order to support a rotation member in the casing. However, it is preferable to reduce the number of the bearing even a little in order to enhance an assembling performance of the power transmission system. Moreover, if it is not to support directly by the bearing inside end of the primary shaft and the inside end of the primary shaft is supported via the clutch output shaft to be engaged and to be coupled on inside end of the primary shaft, it results in not only generating a vibration by a backlash at the engaging portion between the primary shaft and the clutch output shaft, but also to becoming bottleneck in view of enhancing durability of the system. In addition, such as the conventional technology which incorporates small bearing inside the bearing for clutch that is larger than the small bearing and assembles these bearings by a circlip which is a retaining ring in a ring-shape, a man-hour for assembling bearing needs not only to complicate a system but also to be not able to reduce manufacturing cost.

### SUMMARY OF THE INVENTION

An object of the present invention is to enhance the assembling performance of the primary shaft and the crankshaft of continuously variable transmission to be coupled on the crankshaft via the centrifugal clutch.

The power transmission system of an engine for transmitting engine power to a driving wheel, the power transmission system comprises a crankshaft rotatably mounted on a case; a primary shaft disposed coaxially to the crankshaft of a belt-type continuously variable transmission provided with a variable groove width primary pulley having a fixed pulley and a movable pulley; a centrifugal clutch mounted between the crankshaft and the primary shaft; a bearing for said crankshaft provided in the case for supporting the crankshaft at outside of a balance weight of the crankshaft; a clutch drum fixed on an inside end of the primary shaft, the clutch drum configuring said centrifugal clutch by an inner plate mounted on the crankshaft; a bearing for a first transmission provided in the case and jointed to the inside end; a bearing for a second transmission provided in the case and jointed to the outside end of said primary shaft; and the primary shaft supported rotatably by said outside end and the inside end fixed to the clutch drum.

The power transmission system of an engine wherein a flange portion fixed to the clutch drum is provided at the inside end, a recess portion for accommodating an end of the crankshaft is formed at the inside end; and the inside end is fixed to the clutch drum by the flange portion.

The power transmission system of an engine wherein a ring is disposed between the bearing for the first transmission and the fixed pulley; the fixed pulley and a cylindrical collar supporting a movable pulley opposite to the fixed pulley movably in an axial direction are fixed to the primary shaft by a nut screw-engaged with outside end of the primary shaft; and the nut adds fixation force in a thrust direction to an inner ring of the bearing for the first transmission via the ring.

The power transmission system of an engine wherein a stopper provided in the inside end fixes the inner ring of the bearing for the first transmission to the primary shaft; and the case and a lid member attached to the case fixing an outer ring of the bearing for the first transmission to the case.

According to the present invention, since the bearing supporting the crankshaft and the primary shaft which is supported coaxially to an axis of the crankshaft at bearing of the inside end and outside end, it enables the centrifugal clutch of the clutch drum, the crankshaft, and primary shaft to support at less number of bearing. In the present invention, not only can it reduce the number of parts, but also can it enhance the assembling performance.

Together with the collar by which movable pulley is slidably supported and the fixed pulley are fixed to the primary shaft by nut, it enables the inner ring of the bearing to apply thrust force in a state where internal stress is generated in the primary shaft by applying fastening force to the bearing supporting the inside end of the primary shaft by the nut, therefore, mechanical strength of the clutch drum and the primary shaft can be enhanced.

### BRIEF DESCRIPTIONS OF THE DRAWINGS

FIG. 1 is a perspective view showing one example of ATV;

FIG. 2 is a schematic view showing the power transmission system mounted on all terrain vehicle shown in FIG. 1;

FIG. 3 is a cross-sectional view taken on line A-A of FIG. 2;

FIG. 4 is a cross-sectional view in which a part shown in FIG. 2 is enlarged; and

FIG. 5 is another embodiment of the power transmission system in which a cross-sectional view shows the same part of that as FIG. 4.

### DESCRIPTIONS OF THE PREFERRED EMBODIMENTS

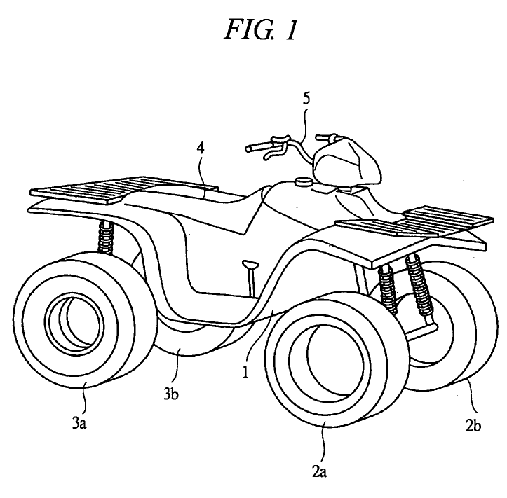

Hereinafter, explanation of an embodiment of the present invention is made on the basis of drawings. As shown in FIG. 1, a vehicle body 1 is provided with front wheels 2a, 2b and rear wheels 3a, 3b and a saddle type seat 4 is provided in the center of the vehicle 1. A driver sitting on the seat 4 operates a handlebar 5 to drive the vehicle 1.

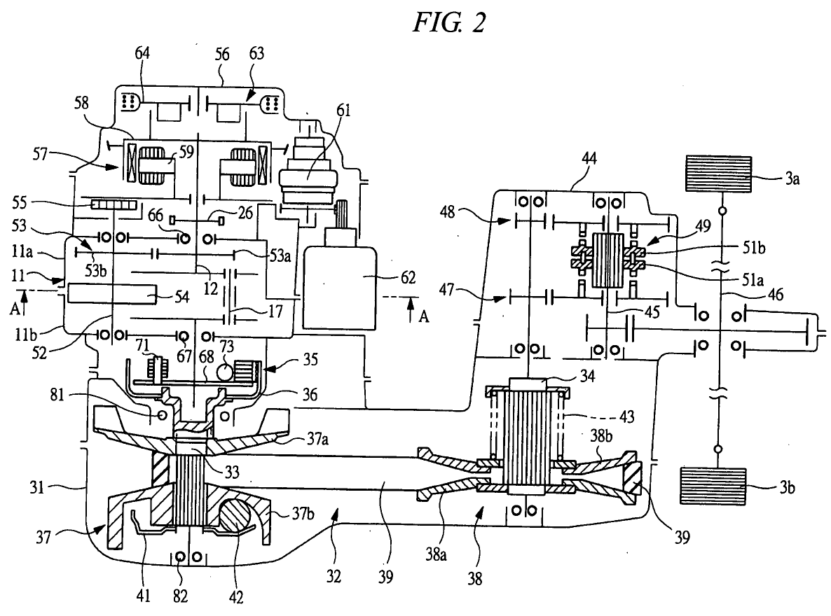

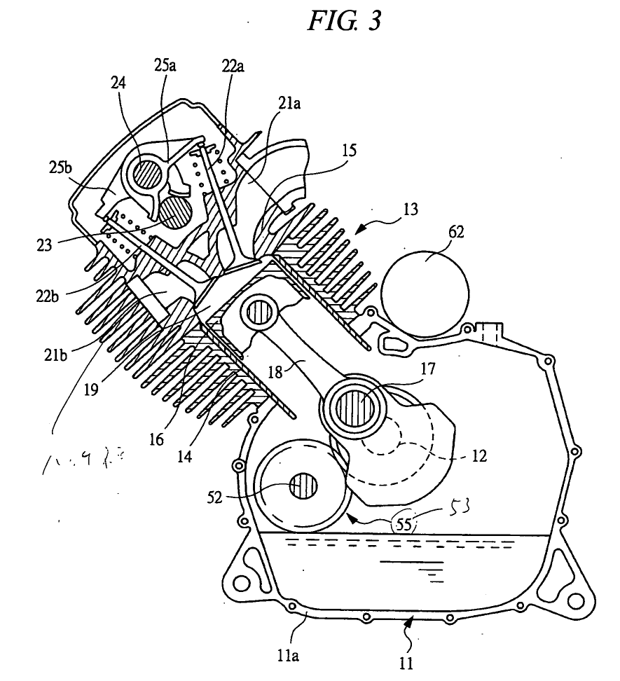

As shown in FIG. 2, a crankcase 11 is assembled with a first case body 11a and a second case body 11b by confronting each other. The crankshaft 12 is rotatably mounted in the crankcase 11. As shown in FIG. 3, on the crankcase 11, an engine 13 is mounted. As shown in FIG. 3, the engine 13 is provided with a cylinder 14 fixed to the crankcase 11 and a cylinder head 15 is fixed to a top of the cylinder 14. A piston 16 is put in a cylinder bore formed in the cylinder 14 in such a way as to freely reciprocate. A connecting rod 18 is coupled between a crank pin 17 fixed to the crankshaft 12 at an eccentric position with respect to its rotary center and the piston 16. Then, the crankshaft 12 is rotated by the engine 13.

As shown in FIG. 3, an intake port 21a opening to a combustion chamber 19 is formed in the cylinder head 15 and an intake valve 22a for opening or closing this intake port 21a is mounted on the cylinder head 15. Also, an exhaust port 21b opening to the combustion chamber 19 is formed in the cylinder head 15 and an exhaust valve 22b for opening or closing this exhaust port 21b is mounted on the cylinder head 15. A camshaft 23 is rotatably mounted on the cylinder head 15. A rocker arm 25a for opening or closing the intake valve 22a and a rocker arm 25b for opening or closing the exhaust valve 22b are mounted on a rocker shaft 24 provided parallel to the camshaft 23 in such a way that they can freely turn. As shown in FIG. 2, a timing chain (not shown) is looped between a sprocket (not shown) fixed to the camshaft 23 and a sprocket 26 fixed to the crankshaft 12. Then, the intake valve 22a and the exhaust valve 22b are opened or closed at predetermined timings by the rotation of the crankshaft 12 via the camshaft 23 and the rocker arms 25a, 25b.

As shown in FIG. 2, a transmission case 31 is mounted on the crankcase 11. In the transmission case 31, belt-type continuously variable transmission 32 is built. The continuously variable transmission 32 has a primary shaft 33 which is rotatably mounted on the transmission case 31 which is formed coaxially to the crankshaft 12, a secondary shaft 34 which is in parallel to the primary shaft 33 rotatably in the transmission case 31 and the secondary shaft 34 rotatably mounted, and the primary shaft 33 is coupled to a clutch drum 36 of a centrifugal clutch 35 built between the primary shaft 33 and the crankshaft 12.

A variable groove width primary pulley 37 is mounted on the primary shaft 33. The primary pulley 37 is constructed of a fixed pulley 37a which is fixed to the primary shaft 33 to integrally rotate, and a movable pulley 37b which is mounted on the primary shaft 33 movable axially and integrally rotate. The variable groove width secondary pulley 38 is mounted on the secondary shaft 34. The secondary pulley 38 is constructed of a fixed pulley 38a which is fixed to the secondary shaft 34 to integrally rotate, and a movable pulley 38b which is mounted on the secondary shaft 34 movable axially and integrally rotate. A V-belt made of rubber is looped over the primary pulley 37 and the secondary pulley 38. When the diameter of a loop of the V-belt 39 looped over the primary pulley 37 and the diameter of a loop of the V-belt 39 looped over the secondary pulley 38 are changed, the rotation of the primary shaft 33 is continuously varied in a transmission gear ratio and is transmitted to the secondary shaft 34. A plurality of cylindrical centrifugal weights 42 are mounted on the primary pulley 37 by a cam plate 41 fixed to the primary shaft 33 in a direction perpendicular to the center of rotation of the primary shaft 33. In order to add a force for fastening the V-belt 39, the secondary shaft 34 is provided with a compression coil spring 43.

Therefore, when the number of revolutions of the primary shaft 33 is increased in a state where the number of revolutions of the crankshaft 12 is increased to the number of revolutions more than a predetermined number under a condition where the primary shaft 33 and the crankshaft 12 are coupled with each other, the centrifugal weights 42 are moved to the outside in the radical direction by centrifugal forces applied thereto to narrow the groove width of the primary pulley 37 to increase the diameter of a loop of the V-belt 39 looped over this primary pulley 37. With this, the groove width of the secondary pulley 38 is widened against the spring force to decrease the diameter of a loop of the V-belt 39 looped over the secondary pulley 38 to vary the transmission gear ratio of the continuously variable transmission 32 to a higher speed side.

As shown in FIG. 2, a gear case 44 is mounted on the transmission case 31. In the gear case 44, the secondary shaft 34 is supported. In addition, an output shaft 45 is rotatably mounted parallel to the secondary shaft 34. Further, a vehicle shaft 46 is rotatably mounted parallel to the output shaft 45. The vehicle shaft 46 shown in FIG. 1 is directly coupled to rear wheels 3a, 3b. Between the secondary shaft 34 and output shaft 45, a forward gear train 47 comprised of a gear provided integrally with the secondary shaft 34 and a gear mounted rotatably with the output shaft 45 is provided, in addition, a backward gear train 48 comprised of a gear provided with the secondary shaft 34 integrally, a gear mounted on the output shaft 45 rotatably, and an idler gear, not shown, engaged therewith is provided.

In order to switch the rotational direction of the output shaft 45, the output shaft 45 is provided with a forward/backward switching mechanism 49. The forward/backward switching mechanism 49, as shown in FIG. 2, has switching disks 51a, 51b each engaged with the spline formed on the output shaft 45. These switching disks 51a, 51b are mounted on the output shaft 45 in such a way as to slide freely in an axial direction. When the switching disk 51a is engaged with the gear train 47, the rotation of the secondary shaft 34 becomes forward rotation and is transmitted to the vehicle shaft 46 to move forward the vehicle. On the other hand, when the switching disk 51b is engaged with the gear train 48, the rotation of the secondary shaft 34 is changed into backward rotation and is transmitted to the vehicle shaft 46 to move backward the vehicle.

As shown in FIG. 2, on the crankcase 11, a balancer shaft 52 is mounted rotatably in parallel to the crankshaft 12. The balancer shaft 52 is coupled on the crankshaft 12 via a gear train 53 which is composed of a driving gear 53a fixed on the crankshaft 12 and a driven gear 53b fixed on the balancer shaft 52. With the balancer shaft 52, a balance weight 54 is integrally provided, in addition, on the balancer shaft 52, a rotor of an oil pump 55 is mounted. A lubricant oil discharged from the oil pump 55 is supplied to a sliding portion in power transmission system via oil path (not shown).

On the crankcase 11, as shown in FIG. 2, a power generation member case 56 is mounted, in the power generation member case 56, a power generation member 57 is provided. The power generation member 57 has an outer rotor 58 attached to the crankshaft 12 and a stator 59 attached to the crankcase 11. Therefore, when the engine 13 is activated to rotate the crankshaft 12, electric power generated by the power generation member 57 is charged into (not shown) a battery.

In order to configure the power transmission system, a case is formed, by the crankcase 11, the transmission case 31 and the power generation member case 56, these cases in which the above-mentioned parts are accommodated. By attaching the case at a vehicle body, the power transmission system is mounted on the vehicle body.

To start the engine, in the power generation member case 56, a starter 61 is mounted, and the starter 61 is driven by an electric motor 62 attached to the crankcase 11. In a case where an amount of charge of the battery lacks so that the engine 13 is not able to start by the starter 61, in order to start the engine 13 by hand, a recoil starter 63 is mounted in the power generation member case 56. The recoil starter 63 has a recoil pulley 64 wound by a recoil rope. By pulling the recoil rope to rotate the recoil pulley 64, the crankshaft 12 rotates thereby starting the engine 13 even by hand.

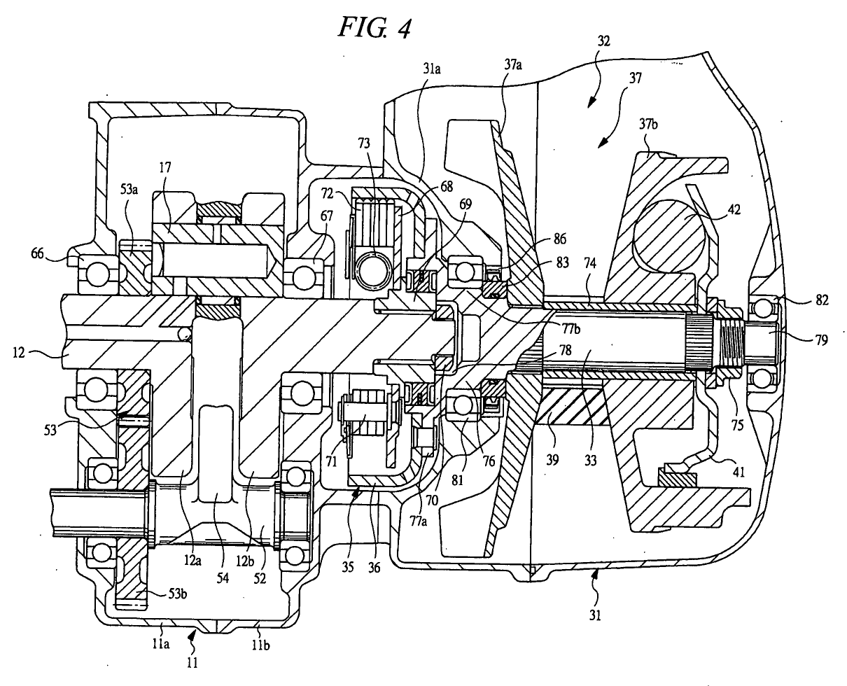

FIG. 4 is cross-sectional view showing by enlarging a part of FIG. 2. The crankshaft 12 is rotatably supported by a bearing 66 for the crankshaft provided in the case member 11a and a bearing 67 for the crankshaft provided in the case member 11b in a case, that is, in the crankcase 11. One bearing 66 is close to the balance weight portion 12a of the crankshaft 12 via the gear 53a, another bearing 67 is close to the balance weight portion 12b. Each of the bearings 66, 67 is disposed outside with respect to the balance weight portions 12a, 12b.

In an end of the continuously variable transmission 32 side of the crankshaft 12, an inner plate 68 is provided toward radial direction with respect to the crankshaft 12. The inner plate 68 is fixed to the crankshaft 12 by a boss portion 69 with a spline connection with the crankshaft 12. The boss portion 69 is fixed to the crankshaft 12 by a nut 70. On the inner plate 68, by a supporting pin 71 fixed to the inner plate, centrifugal weight shoes 72 are rotatably mounted. Spring force is applied to the centrifugal weight shoes 72 toward direction from a free end portion of the centrifugal weight shoes to a separating inner surface of the clutch drum 36 by a coil spring 73. In a case where revolutions number of crankshaft 12 becomes greater or equal to a predetermined number, by centrifugal force, the centrifugal weight shoes 72 turn outward. A portion of the free end of the centrifugal weight shoes 72 is contacted to an inner circumferential surface of the clutch drum 36. The clutch drum 36 rotates together with the crankshaft 12 integrally to transmit rotation to the primary shaft 33.

The fixed pulley 37a is connected to the primary shaft 33 in spline connection. As confronting one end surface to an inner surface of the fixed pulley 37a, a cylindrical collar 74 is jointed to the primary shaft 33. The movable pulley 37b is slidable in an axis direction in such a manner as a spline formed on outer circumferential surface of the collar 74 is engaged with the movable pulley 37b. As confronting another end surface of the collar 74, the cam plate 41 is fixed to the primary shaft 33. By the nut 75 screw-connected at outside end of the primary shaft 33, the fixed pulley 37a, the collar 74, and the cam plate 41 are fixed to the primary shaft 33.

The crankshaft side end of the primary shaft 33, i.e., the inside end 76 is provided with a flange portion 77a and a journal portion 77b fixed to the clutch drum 36. In the primary shaft 33, recess portion 78 is formed corresponding to the flange portion 77a and the journal portion 77b. The boss portion 69 and the nut 70 intrude at an end of the crankshaft 12 in the recess portion 78. An inner ring of a bearing 81 of a first transmission is jointed to the journal portion 77b of the inside end 76 of the primary shaft 33. An external ring of the bearing 81 is provided in the transmission case 31 and is jointed to a party wall 31a constituting a part of the transmission case 31. An end surface of either one of the internal ring confronts with a flange portion 77a. Another end surface of the external ring confronts with a surface in radial direction of the party wall 31a. The inside end 76 of the primary shaft 33 is rotatably supported with respect to the party wall 31a by the bearing 81. On one hand, an internal ring of a bearing 82 for a second transmission is jointed to an outside end 79 of the primary shaft 33, an external ring of the bearing 82 is jointed to an installation hole of the transmission case 31, and the outside end 79 of the primary shaft 33 is rotatably supported in the case.

Like this, the primary shaft 33 is rotatably supported in the case by the bearing 81 jointed to the outer circumferential surface of the inside end 76 of the primary shaft 33 and the bearing 82 jointed to the outer circumferential surface of the outside end 79, and the clutch drum 36 is integrally fixed to the primary shaft 33 via the flange portion 77a. Therefore, the bearing 81 supports the clutch drum 36 of the centrifugal clutch 35 also rotatably in the transmission case 31. Thereby, even if stress is applied to the crankshaft 12 and the primary shaft 33 at the time period of transmitting power, it is not necessary to provide small bearing between the crankshaft 12 and the clutch drum 36. In total, four bearings, that is, bearings 66, 67 for two crankshafts of the crankshaft 12 and the primary shaft 33, and bearings 81, 82 for two transmissions, they are formed coaxially, i.e., rotation center axes of each axis coincide with each other so as to support them. Like this, since the crankshaft 12 and the primary shaft 33 is coaxially supported, if revolutions number of the crankshaft 12 becomes greater or equal to a predetermined number, the inner circumferential surface of the clutch drum 36 contacts with the free end of the centrifugal weight shoes 72 to be securely able to transmit rotation of the crankshaft 12 to the primary shaft 33.

In the inside end 76, a ring 83 is jointed between the bearing 81 and the fixed pulley 37a such as to be sandwiched. The internal ring of the bearing 81 is sandwiched between the flange portion 77a and a ring 83. When the nut 75 is tightened up, fastening force in a thrust direction, in other words, the axial direction added to the primary shaft 33 by the nut 75 becomes fastening force with respect to the bearing 81 added by the flange portion 77a and the ring 83. Therefore, in a state where stress is generated inside of the primary shaft 33 by the nut 75, the clutch drum 36 and the primary pulley 37 are able to be assembled via the primary shaft 33, and in a state where fastening force is added to the bearing 81 by internal stress, the clutch drum 36 and the primary shaft 33 can be securely combined therewith.

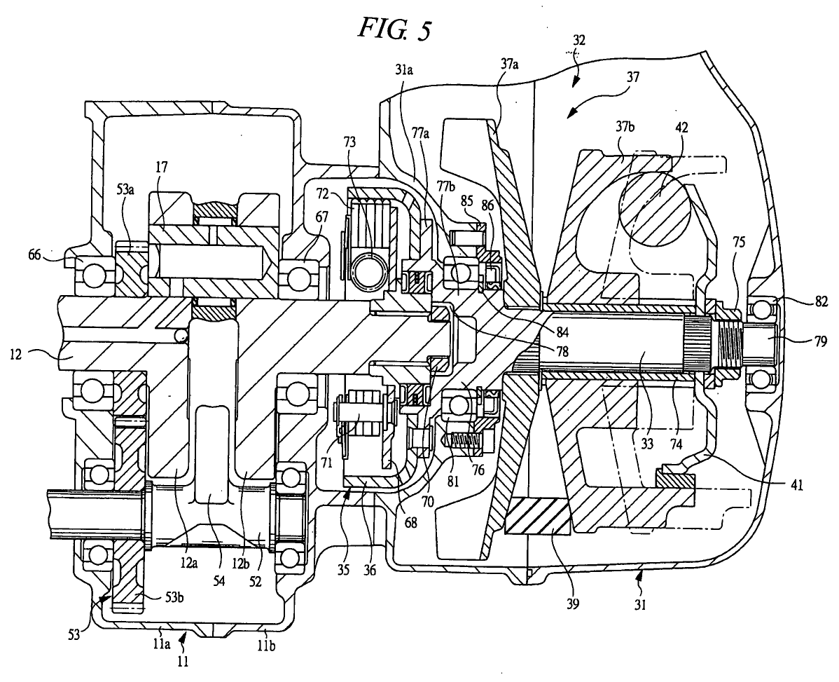

FIG. 5 is another embodiment of the power transmission system of the present invention, and cross-sectional view the same as parts in FIG. 4. In FIG. 5, the same member as aforementioned member in the above embodiment donates same reference symbol. In this power transmission system, it is not provided with the ring 83 in FIG. 4, the fixed pulley 37a strikes an end surface of a journal portion 77b, a circlip 84 which is a circular stopper is stopped and kept in a mounting groove formed in the journal portion 77b, and the internal ring of the bearing 81 is fixed by the circlip 84 and the flange portion 77a.

In a case shown in FIG. 5, in order to fix the external ring of the bearing 81 to the party wall 31a, a lid member 85 is attached to the party wall 31a, in addition of this lid member 85, a mechanical seal 86 for preventing lubricant oil of a crank chamber from flowing in the continuously variable transmission 32 is mounted on. In a case of FIG. 4, the mechanical seal 86 is mounted on between the party wall 31a and the ring 83.

As mentioned above, in power transmission system of the present invention, since the clutch drum 36 of the centrifugal clutch 35 and the primary shaft 33 are combined with each other at part of the inside end 76, the primary shaft 33 and the clutch drum 36 by two bearings 81, 82 are rotatably supported in the case, small bearing is not necessary to be mounted on between the crankshaft 12 and the clutch drum 36, the number of bearing can be reduced in comparison with that in conventional art, and assembling performance of the power transmission system can be enhanced.

It should be understood that the present invention is not limited to the above-mentioned embodiments but can be variously modified within the sprit and scope of the present invention. For example, the power transmission system of the present invention can be applied to ATV vehicle in which the crankshaft 12 and the primary shaft 33 of the belt-type continuously variable transmission are disposed coaxially, the centrifugal clutch 35 between the crankshaft 12 and the primary shaft 33 is mounted, and kind of engine 13 is not limited to four-cycle engine but may mount two-cycle engine.

The entire disclosure Japanese Patent Application No. JP 2004-111326 filed on Apr. 5, 2004 including specification, claims, drawings and summary is incorporated herein by reference in its entirely.

1. A power transmission system of an engine for transmitting engine power to a driving wheel, said power transmission system comprising:
a crankshaft rotatably mounted on a case;
a primary shaft disposed coaxially to said crankshaft of a belt-type continuously variable transmission provided with a variable groove width primary pulley having a fixed pulley and a movable pulley;
a centrifugal clutch mounted between said crankshaft and said primary shaft;
a bearing for said crankshaft provided in said case for supporting said crankshaft at outside of a balance weight of said crankshaft;
a clutch drum fixed on an inside end of said primary shaft, said clutch drum configuring said centrifugal clutch by an inner plate mounted on said crankshaft;
a bearing for a first transmission provided in said case and jointed to said inside end;
a bearing for a second transmission provided in said case and jointed to said outside end of said primary shaft; and
said primary shaft supported rotatably by said outside end and said inside end fixed to said clutch drum.

2. The power transmission system of an engine according to claim 1, wherein:
a flange portion fixed to said clutch drum is provided at said inside end, a recess portion for accommodating an end of said crankshaft is formed at said inside end; and
said inside end is fixed to said clutch drum by said flange portion.

3. The power transmission system of an engine according to claim 1, wherein:
a ring is disposed between said bearing for said first transmission and said fixed pulley; said fixed pulley and a cylindrical collar supporting a movable pulley opposite to said fixed pulley movably in an axial direction are fixed to said primary shaft by a nut screw-engaged with outside end of said primary shaft; and said nut adds fixation force in a thrust direction to an inner ring of said bearing for said first transmission via said ring.

4. The power transmission system of an engine according to claim 1, wherein:
a stopper provided in said inside end fixes the inner ring of the bearing for said first transmission to said primary shaft; and said case and a lid member attached to said case fixes an outer ring of the bearing for said first transmission to said case.
